(19) United States
(12) Patent Application Publication
(10) Pub. No.: US 2005/0289148 A1
(43) Pub. Date: Dec. 29, 2005

(54) Method and apparatus for detecting suspicious, deceptive, and dangerous links in electronic messages

(76) Inventors: Steven Dorner, San Diego, CA (US); Randall Coleman Gellens, San Diego, CA (US)

Correspondence Address: QUALCOMM, INC, 5775 MOREHOUSE DR., SAN DIEGO, CA, 92121, US

(21) Appl. No.: 11/147,807

(22) Filed: Jun. 7, 2005

Related U.S. Application Data
(60) Provisional application No. 60/579,023, filed on Jun. 10, 2004.

(51) Int. Cl. G06F 17/30

(52) U.S. Cl. 707/10

(57) ABSTRACT

Described are apparatus and methods for the analysis of characteristics of links intended to deceive a message recipient. The analysis can be employed at the receiving client, an intermediate server, or at other points to help protect the user from fraud without blocking legitimate content. For example, this analysis can be used to warn users attempting to follow such links. This analysis can also be used to mark the links in an indicative way on display. This analysis can also be used as input to spam-scoring algorithms.

### STATEMENT OF RELATED APPLICATIONS

This application claims priority to previously filed U.S. Provisional Patent Application No. 60/579,023, filed on Jun. 10, 2004, and entitled Method And Apparatus For Detection of Suspicious, Deceptive, Dangerous Links in Electronic Messages.

### BACKGROUND

The present invention relates generally to electronic messaging, and more specifically to fraud prevention mechanisms used in the context of electronic messaging.

As electronic messaging has gained popularity, certain types of message-based attacks have become increasingly common. One such attack occurs when an attacker attempts to deceive a message recipient by sending a message that tricks the message recipient into visiting a URL, such as a web site, that is in actuality different from what the message recipient is led to believe by the message.

For example, an attacker may send an e-mail which appears to come from an established company, such as, CitiBank, Amazon, EBay, etc. The e-mail usually has wording intended to make the recipient believe that the recipient should or must visit a web site and verify account information, recent suspicious charges, verify or cancel a transaction, update information, etc. A link in the e-mail also appears to be associated with or going to a web site of the established company. The attacker sends this message to deceive the recipient into activating the link, believing that the recipient will be taken to the legitimate web site of the established entity. In fact, the link will take the recipient to an illegitimate web site under control of the attacker that has been created to look confusingly similar to the established company's legitimate web site. The illegitimate web site is usually very difficult to distinguish from the actual web site operated by the established company. As a result, the recipient may be tricked into revealing sensitive and/or personal information, such as account numbers, passwords, credit card numbers, or other information useful to an attacker. This practice is known as “phishing,” and it is often more successful that one may expect.

Solutions employed today for combating such attacks include, among others, spam filters which look for known strings, known hosts, or other patterns; altering local Domain Name Server (“DNS”) servers to redirect attempts to visit the linked web site to a site maintained by a carrier or Internet service provider; and simply educating and cautioning users.

Notwithstanding these advances, there remains a need in the art for techniques to identify potentially dangerous, misleading, or otherwise suspicious links.

### SUMMARY

Embodiments disclosed herein address the above stated needs by providing techniques for analyzing messages to identify potentially dangerous, misleading, or otherwise suspicious links. In one aspect, the invention envisions a method that may be performed at either a server or a client, the method including the steps of receiving an electronic message, determining if the message includes at least one link, and if so, examining the link to determine if the link includes a characteristic that suggests the link is illegitimate. The method further includes the step of, if the link does include the characteristic, modifying the message to include a warning that the link might be illegitimate, or presenting a warning that the message includes a link that might be illegitimate, or presenting a warning when the receiver attempts to follow the link, using this as input into a spam-scoring algorithm, or some combination of any or all of these. The method may also be embodied as computer-executable instructions encoded on a computer-readable medium.

In another aspect, the invention envisions an apparatus for analyzing an electronic message that includes a computer-readable medium on which is stored computer-executable instructions for persistent storage, a computer memory in which reside the computer-executable instructions for execution, and a processor coupled to the computer-readable medium and the computer memory with a system bus. The processor is operative to execute the computer-executable instructions to receive the electronic message, determine if the message includes at least one link, and if so, examine elements of the link or links to determine if the link includes a characteristic that suggests the link is an illegitimate link. If the link does include the characteristic, the processor is further configured to present a warning that the message includes a link that might be illegitimate. It may also be configured to use this as input in a spam-scoring algorithm.

### BRIEF DESCRIPTION OF THE DRAWINGS

FIG. 1 is a functional block diagram illustrating a messaging environment that includes a server and a remote device for receiving electronic messages.

FIG. 2 is a functional block diagram of one embodiment of the server used in the messaging environment of FIG. 1 that shows the server in more detail.

FIG. 3 is a functional block diagram of one embodiment of the remote device used in the messaging environment of FIG. 1 that shows the messaging client in more detail.

FIG. 4 shows an exemplary process flow for a client-side link analysis engine.

FIG. 5 shows an exemplary process flow for a server-side link analysis engine.

### DETAILED DESCRIPTION

The word “exemplary” is used herein to mean serving as an example, instance, or illustration. Any embodiment described herein as “exemplary” is not to be construed as necessarily preferred or advantageous over other embodiments, but rather merely as one example of an embodiment.

Embodiments disclosed herein provide techniques for analyzing messages at a server, a client, or other entity to identify potentially dangerous, misleading, or otherwise suspicious links. For the purpose of this document, the following terms shall have the meanings ascribed to them here:

“Electronic message” means any electronic communication in any form from a remote or sending device to a local or receiving device. Electronic messages include, but are not limited to, e-mail messages, mobile e-mail messages, Multimedia Messaging Service (“MMS”) messages, Short Messaging Service (“SMS”) messages, Instant Messaging (“IM”) messages, and the like.

“Link” means a hyperlink to content on a wide area network. The hyperlink includes at least a code or first component to direct a hyperlink-aware application to a network location specified in the hyperlink. In addition, the hyperlink may include a second component that defines some alphanumeric content that is displayed in lieu of the location.

“Illegitimate link” means a link to content on a remote device that has an actual location on a wide area network, the actual location being different than another location suggested by at least one characteristic of the link or which serves to obscure the actual location of the link.

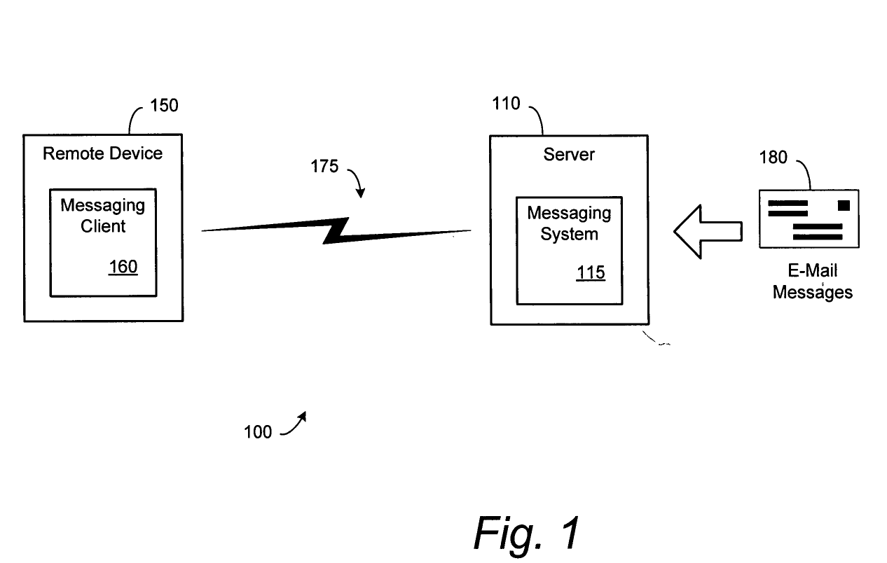

FIG. 1 is a functional block diagram illustrating a messaging environment that includes a server 110 for receiving electronic messages 180, and a remote device 150, which may be, for example, a desktop computer, laptop computer, cell phone, PDA. The server 110 communicates with the remote device 150 over a communications link 175, which may be wireless or wired. Messaging server 110 includes a messaging system 115. Remote device 150 includes a messaging client 160.

In accordance with the invention, an analysis is performed, at the remote device 150 or at the server 110 or both, to identify whether any of the incoming electronic messages 180 include potentially dangerous, misleading, or otherwise suspicious links. Briefly stated, the analysis of a link includes evaluating certain portions of the link for characteristics that suggest it may be an illegitimate link. Additional detail of the analysis is provided below.

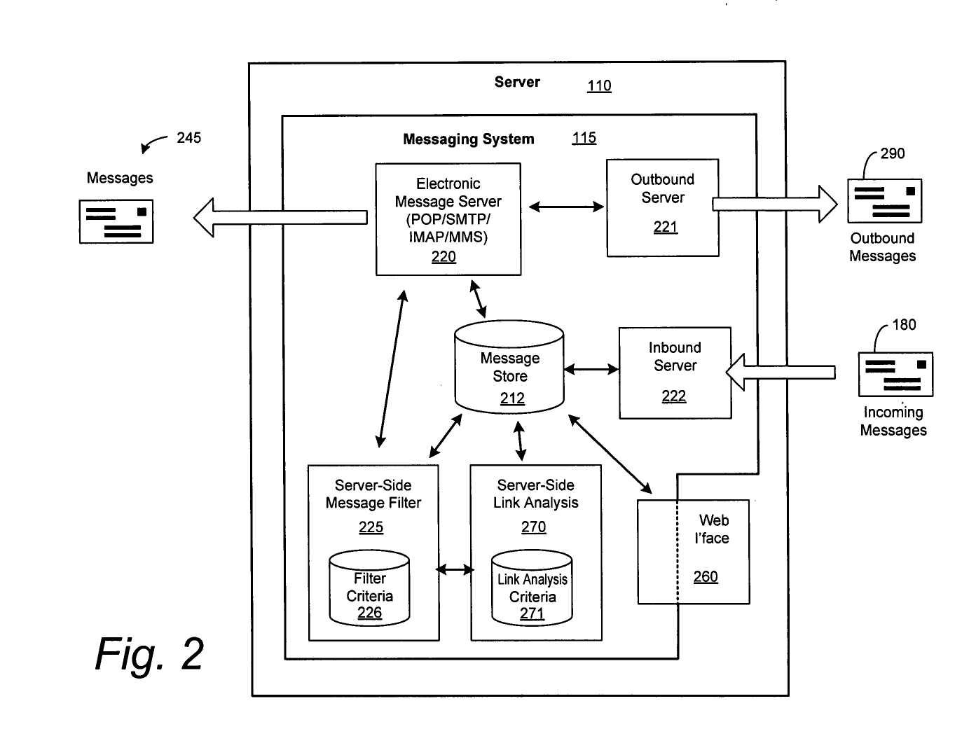

FIG. 2 is a functional block diagram of one embodiment of the server 110 used in the messaging environment of FIG. 1 that shows the server 110 in more detail. In this implementation, the messaging system 115 includes an inbound server 222 to receive incoming messages 180, and an outbound server 221 to transmit outgoing messages 290. The inbound server 222 places incoming messages 180 into a message store 212 where they can be accessed by other components of the messaging system 115.

An electronic message server 220, such as a POP/SMTP, IMAP/SMTP, MMS and/or IM server for example, interacts with a client on a remote device to make incoming messages 180 available to the client and to receive outbound messages 290 from the client for transmission by the outbound server 221. The message server 220 may communicate with or be integrated into other components of the messaging system 115. The message server 220 transmits filtered messages 245 to the client, and also receives outbound messages 290 from the client and transmits them to the outbound server 221 for outbound delivery.

The messaging system 115 may include a server-side message filter 225 to perform a conventional message analysis, such as virus checking and spam filtering. It will be appreciated that this more conventional analysis could include looking for matches to fixed strings anywhere or in specific fields within the message content or protocol, looking for particular situations in specific fields in the message content or protocol (such as long runs of white space in the message subject, a subject or from address which ends in a number, a subject which starts with “Re” in a malformed way (such as lack of colon or space following “Re”), a subject which starts with “Re” in a message which does not contain an ”In-Reply-To” header), looking for anomalies in the protocol, and so forth. The message filter 225 may calculate a spam score used to determine whether to tag a message as spam or not.

In addition, the messaging system 115 includes a server-side link analysis module 270 configured to perform a link analysis on the incoming messages 180. In contrast to the conventional analysis performed by the message filter 225, the link analysis module 270 is specifically configured to analyze links within the incoming messages 180 to identify characteristics that suggest they may be illegitimate links.

The link analysis criteria 271 and/or link analysis module 270 could also be configured with rules or logic to govern what happens in the event that an illegitimate link is found in a message. For instance, if an illegitimate link is found in a message, the link analysis module 270 could delete the message, tag the message as suspect, redirect the message to a special folder, include the illegitimate link information in a spam calculation (e.g., as part of or in conjunction with the filter criteria 226), alter the message to include a warning that the link might be illegitimate, or the like.

In an alternative embodiment, the functionality of the link analysis module 270 may be incorporated into the server-side message filter 225, and the functionality of the link analysis criteria 271 may be incorporated into the filter criteria 226.

There are very many different evaluations that may be performed specifically for the purpose of determining whether a link may be an illegitimate link. Each of those evaluations may be embodied in rules and/or logic within the link analysis criteria 271. What follows are several examples of the types of link characteristics that raise suspicion during evaluation. These examples are not intended to provide an exhaustive list, but rather to provide guidance on the types of link characteristics that may be examined.

Links that use an IP address instead of a host name in the URL are suspicious because they are often used in malicious ways, but do sometimes have legitimate purposes (such as if the IP address is within a local network such as a corporate or university campus where the individual users' machines do not have unique host names). One example of such a link includes a URL of the form “http://129.46.50.5/somepathinfo”. If the address space of the IP address is in a different allocation block from the intended recipient of the message, the link could be treated with even greater scrutiny, as it suggests that the sender and recipient are not members of the same local network.

A link may be suspicious if the display text contains a host name or link very similar to but different from the actual link. For example, if the link is implemented as a HyperText Markup Language (“HTML”) “anchor” tag, the tag could take the following form:

<a href=“http://www.stealyourinfo.com”>http://www.paypal.com<a>

Where “http://www.stealyourinfo.com” is the actual target of the hyperlink, but the text “http://www.paypal.com” will be displayed as if it were the actual target. This technique is commonly used to deceive the casual web user. Although the anchor tag is illustrated here, there may be several other situations in which this deceptive technique could be used. Other examples where the display text is similar to but different from the link address include where similar-appearing characters are used; for example, the digit zero, the letter “O”, and the letter “Q” may appear similar; the digit “1”, the letter “L”, and the letter “I” may appear similar, and so on, especially with certain fonts and cases, and may also apply to many situations with internationalized domain names.

A link may be suspicious if it contains encoded characters, whitespace, top level domains that are not at the top level, or other unusual elements. The following link target illustrates one specific instance of this situation:

href=“http://www.service.paypal.com.to”

Where the address is cleverly intended to look like it points to a “service” machine within the domain “paypal.com”, when in actuality the address points to a “paypal” machine within the “com.to” domain. The owner of the domain “com.to” would almost certainly not be the same entity as the owner of the domain “paypal.com”. Thus, the user would likely be confused about who actually controls the content on that site. This is another common tactic.

A link may be suspicious if the URL of the link points to a site that is not a subdomain of the domain indicated in a “From:” header of the message. In other words, if the domain of the sender of the message is “qualcomm.com”, for example, any link within the message that points outside the “qualcomm.com” domain might be suspicious. Although this technique is more likely to be a valid link than the preceding tactics, it could still be one factor in the overall analysis.

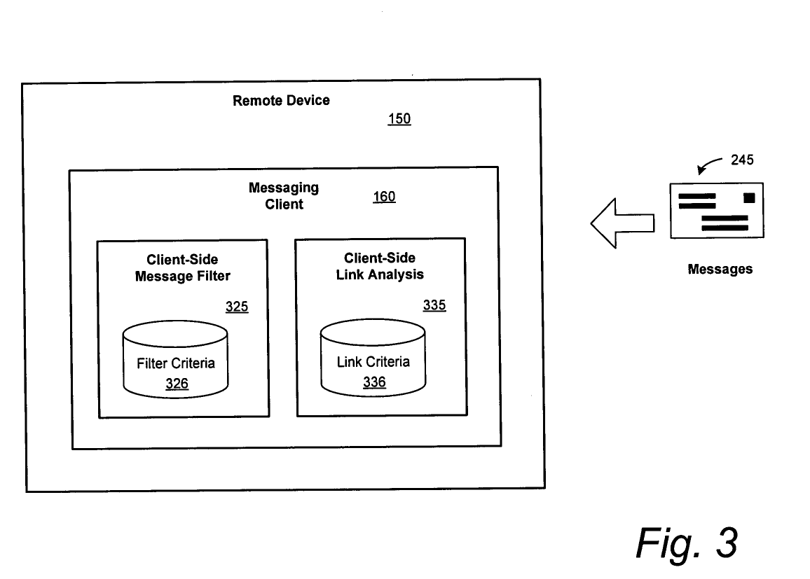

FIG. 3 is a functional block diagram of one embodiment of the remote device 150 used in the messaging environment of FIG. 1 that shows the messaging client 160 in more detail. As mentioned above, the remote device 150 can be any computing device configured to send and receive electronic messages, such as a handheld or mobile computing device, a laptop computer, a remote desktop computer, and the like. The messaging client 160 is configured to interact with the message server 220 (FIG. 2) to receive messages 245.

The messaging client 160 includes a client-side message filter 325 that is responsible for conventional message analysis on incoming messages 245. For example, the message filter 325 may be configured to apply rules based logic, stored in the message filter criteria 326, to calculate a likelihood that a message is spam or is otherwise undesirable. Filter criteria 326 could also include rules to direct incoming messages 245 to special storage folders or locations, perhaps based on task, thread, or sender. The client-side message filter 325 may be configured in substantially the same fashion as the server-side message filter 225 (FIG. 2).

The messaging client 160 also includes a client-side link analysis module 335 which includes link criteria 336. On the remote device 150, the link analysis module 335 is configured to analyze incoming messages 245 in substantially the same manner as was described above for the server-side link analysis module 270 (FIG. 2). In other words, each of the tests or evaluations that were described above in conjunction with the server-side link analysis module 270 could be implemented by the client-side link analysis module 335. Accordingly, each of those tests and evaluations will not be repeated here.

Also, as mentioned above in connection with the server, the analysis performed by the client-side link analysis module 335 could be used as input to a spam score or related algorithm or filter criteria 326 which is then further evaluated by the client-side message filter 325. In addition or in the alternative, the result of the analysis by the link analysis module 335 could be used to directly notify or warn the user about the message as a whole, or any of its links that appear dangerous or suspicious. This notification could take the form of a pop-up dialog or other warning, or a special tag included with the message to indicate the possibility of an illegitimate link in the message.

The link analysis module 335 could also be configured to alter, intercept, or interpret any links suspected of being an illegitimate link so that any attempt by a user to click on or follow that link results, for example, in a warning and/or in simply blocking the attempted navigation. For links below some threshold, but still identified as potentially dangerous, the user could be optionally informed or warned to a lesser degree. For example, the link may appear in a special color or font, a warning could be displayed when the user selects or puts the cursor or mouse over the link, etc.

In an alternative embodiment, the functionality of the link analysis module 335 may be incorporated into the client-side message filter 325, and the functionality of the link analysis criteria 336 may be incorporated into the filter criteria 326.

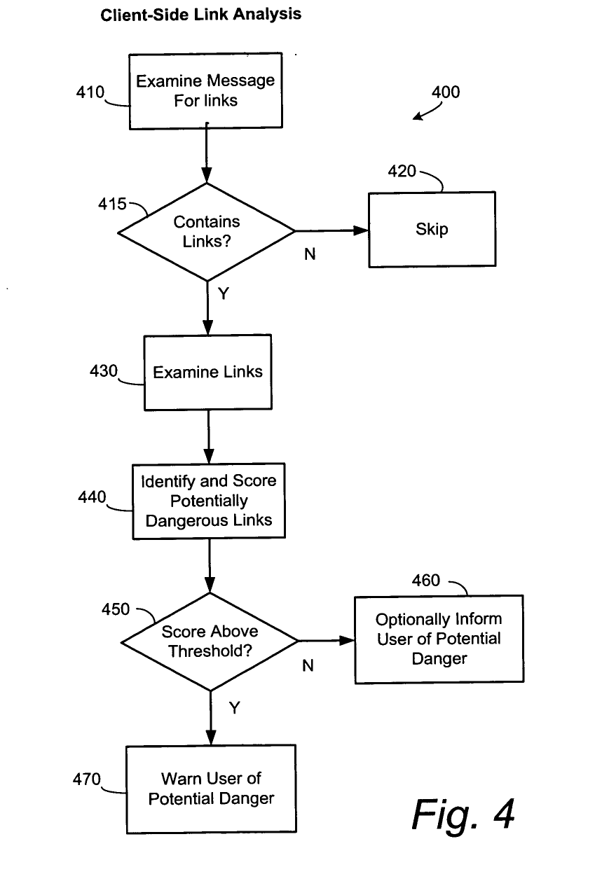

FIG. 4 shows an exemplary process flow 400 for a client-side link analysis engine. At block 410, messages are examined for links, and at block 415 it is determined whether the messages include any links. If links are not found, then at block 420, the message is skipped. However, if any links are found, then at block 430 those links are examined. At block 440, any potentially dangerous links are identified and scored for potential danger. At block 450, it is determined if the resulting score for the message as a whole or for any link is above a threshold. If the score is below the threshold, at block 460, the user can optionally be warned or informed of potential danger. If the score is above the threshold, at block 470, the user is warned or other action is taken. For example, the message may be deleted or rejected.

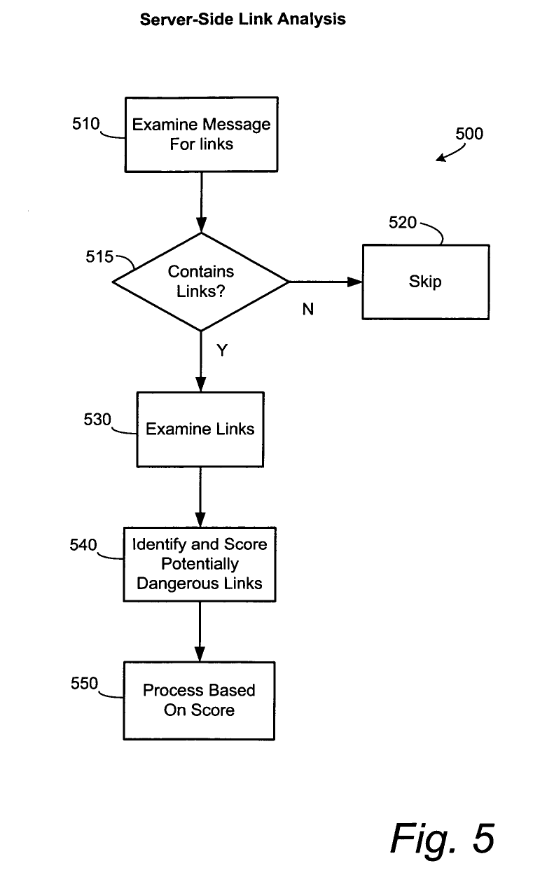

FIG. 5 shows an exemplary process flow 500 for a server-side link analysis engine. At block 510, messages are examined for links, and at block 515 it is determined whether the messages include any links. If links are not found, then at block 520, the message is skipped. However, if any links are found, then at block 530 those links are examined. At block 540, any potentially dangerous links are identified and scored for potential danger. At block 550, messages are processed in various ways in part depending on the link analysis score. For example, the messages can be processed according to the resulting score for the message as a whole or any link.

Analysis of characteristics of links intended to deceive can be much more effective than other techniques, and can be employed at the receiving client, an intermediate server, or at other points. This analysis can be used to warn users attempting to follow such links, to mark the links in an indicative way on display, as input to spam-scoring algorithms, or in other ways that help protect the user from fraud without blocking legitimate content.

Those skilled in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable a person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A computer-implemented method performed at a server for analyzing an electronic message, the method comprising:
receiving, at the server, the electronic message;
determining if the message includes at least one link;
if the message includes a link, examining the link to determine if the link includes a characteristic that suggests the link is an illegitimate link; and
if the link does include the characteristic, modifying the message to include a warning that the link might be illegitimate.

2. The computer-implemented method recited in claim 1, wherein the electronic message comprises a markup language code that defines the link.

3. The computer-implemented method recited in claim 2, wherein the markup language code includes a target for the link, the target being a location on a wide area network, the target comprising a Universal Resource Locator (“URL”) identifying a domain on the wide area network.

4. The computer-implemented method recited in claim 3, wherein the characteristic that suggests the link is illegitimate comprises the domain being represented as an Internet Protocol address.

5. The computer-implemented method recited in claim 3, wherein the markup language code further includes a display text portion and wherein the characteristic that suggests the link is illegitimate comprises the display text portion having a string that identifies a display domain that is different from the domain of the target of the link.

6. The computer-implemented method recited in claim 3, wherein the characteristic that suggests the link is illegitimate comprises the domain of the target of the link including a top-level domain portion that is represented in the URL in a location other than at a top-level domain location.

7. The computer-implemented method recited in claim 3, wherein the electronic message comprises a header that identifies a sender's domain, and wherein the characteristic that suggests the link is illegitimate comprises the domain of the target being outside the sender's domain.

8. The computer-implemented method recited in claim 1, wherein the method further comprises performing a score-based analysis to calculate a likelihood that the link is illegitimate.

9. The computer-implemented method recited in claim 8, further comprising including that likelihood in a conventional message analysis.

10. The computer-implemented method recited in claim 8, further comprising if the likelihood exceeds a given threshold, processing the message as if the link is illegitimate, and if the likelihood does not exceed the given threshold, identifying the message as having a suspicious link.

11. A computer-implemented method performed at a client for analyzing an electronic message, the method comprising:
receiving, at the client, the electronic message;
determining if the message includes at least one link;
if the message includes a link, examining the link to determine if the link includes a characteristic that suggests the link is an illegitimate link; and
if the link does include the characteristic, presenting a warning that the message includes a link that might be illegitimate.

12. The computer-implemented method recited in claim 11, wherein the electronic message comprises a markup language code that defines the link.

13. The computer-implemented method recited in claim 12, wherein the markup language code includes a target for the link, the target being a location on a wide area network, the target comprising a Universal Resource Locator (“URL”) identifying a domain on the wide area network.

14. The computer-implemented method recited in claim 13, wherein the characteristic that suggests the link is illegitimate comprises the domain being represented as an Internet Protocol address.

15. The computer-implemented method recited in claim 13, wherein the markup language code further includes a display text portion and wherein the characteristic that suggests the link is illegitimate comprises the display text portion having a string that identifies a display domain that is different from the domain of the target of the link.

16. The computer-implemented method recited in claim 13, wherein the characteristic that suggests the link is illegitimate comprises the domain of the target of the link including a top-level domain portion that is represented in the URL in a location other than at a top-level domain location.

17. The computer-implemented method recited in claim 13, wherein the electronic message comprises a header that identifies a sender's domain, and wherein the characteristic that suggests the link is illegitimate comprises the domain of the target being outside the sender's domain.

18. The computer-implemented method recited in claim 11, wherein the method further comprises performing a score-based analysis to calculate a likelihood that the link is illegitimate.

19. The computer-implemented method recited in claim 18, further comprising including that likelihood in a conventional message analysis.

20. The computer-implemented method recited in claim 18, further comprising if the likelihood exceeds a given threshold, processing the message as if the link is illegitimate, and if the likelihood does not exceed the given threshold, identifying the message as having a suspicious link.

21. A computer-readable medium encoded with computer-executable instructions for analyzing an electronic message, the instructions comprising:
receiving the electronic message;
determining if the message includes at least one link;
if the message includes a link, examining elements of the link to determine if the link includes a characteristic that suggests the link is an illegitimate link; and
if the link does include the characteristic, presenting a warning that the message includes a link that might be illegitimate.

22. The computer-readable medium recited in claim 21, wherein the link is illegitimate if the link includes a target that points to content on a remote device that has a location on a wide area network, the location being different than another location suggested by the characteristic.

23. The computer-readable medium recited in claim 21, wherein the electronic message comprises a markup language code that defines the link.

24. The computer-readable medium recited in claim 23, wherein the markup language code includes a target for the link, the target being a location on a wide area network, the target comprising a Universal Resource Locator (“URL”) identifying a domain on the wide area network.

25. The computer-readable medium recited in claim 24, wherein the characteristic that suggests the link is illegitimate comprises the domain being represented as an Internet Protocol address.

26. The computer-readable medium recited in claim 24, wherein the markup language code further includes a display text portion and wherein the characteristic that suggests the link is illegitimate comprises the display text portion having a string that identifies a display domain that is different from the domain of the target of the link.

27. The computer-readable medium recited in claim 24, wherein the characteristic that suggests the link is illegitimate comprises the domain of the target of the link including a top-level domain portion that is represented in the URL in a location other than at a top-level domain location.

28. The computer-readable medium recited in claim 24, wherein the electronic message comprises a header that identifies a sender's domain, and wherein the characteristic that suggests the link is illegitimate comprises the domain of the target being outside the sender's domain.

29. An apparatus for analyzing an electronic message, comprising:
a computer-readable medium on which is stored computer-executable instructions for persistent storage;
a computer memory in which reside the computer-executable instructions for execution; and
a processor coupled to the computer-readable medium and the computer memory with a system bus, the processor being operative to execute the computer-executable instructions to:
receive the electronic message;
determine if the message includes at least one link;
if the message includes a link, examine elements of the link to determine if the link includes a characteristic that suggests the link is an illegitimate link; and
if the link does include the characteristic, present a warning that the message includes a link that might be illegitimate.

30. An apparatus for analyzing an electronic message, comprising:
means for receiving the electronic message;
means for determining if the message includes at least one link;
if the message includes a link, means for examining elements of the link to determine if the link includes a characteristic that suggests the link is an illegitimate link; and
if the link does include the characteristic, means for presenting a warning that the message includes a link that might be illegitimate.
